(19) United States
(12) Patent Application Publication
(10) Pub. No.: US 2006/0015226 A1
(43) Pub. Date: Jan. 19, 2006

(54) Method for determining a steering torque which acts when a steering wheel is activated in motor vehicles

(76) Inventors: Werner Bernzen, Stuttgart (DE); Wilfried Huber, Stuttgart (DE); Volker Maass, Stuttgart (DE); Reinhold Schneckenburger, Rutesheim (DE); Christian Urban, Stuttgart (DE)

Correspondence Address: FASSE PATENT ATTORNEYS, P.A., P.O. BOX 726, HAMPDEN, ME, 04444-0726, US

(21) Appl. No.: 10/523,139

(22) PCT Filed: Jul. 16, 2003
(86) PCT No.: PCT/EP03/07696

§ 371 Date: Jul. 1, 2005

(30) Foreign Application Priority Data
Jul. 31, 2002 (DE) 102350396

(51) Int. Cl. B62D 11/00

(52) U.S. Cl. 701/41

(57) ABSTRACT

The invention relates to a method for determining a steering torque which acts when a steering wheel is activated in motor vehicles.

In a motor vehicle, the steering torque which acts when a steering wheel is activated is determined. The motor vehicle here is in particular a motor vehicle whose steered wheels are driven. In this context, according to one method according to the invention the interference torque component (M_stör), based on interference influences, of the steering torque is determined. A steering torque (M_soll) with reduced interference force, in particular free of the influence of an interference force, is then generated at the steering wheel by means of a torque generator (108).

The invention relates to a method for determining a steering torque which acts when a steering wheel is activated in a motor vehicle.

When a motor vehicle is in the driving mode, in particular when cornering, forces of different magnitude occur at the steered wheels. This applies not only to the lateral forces acting on the wheel but also to the circumferential forces acting at the wheel contact surface between the wheel and the road.

Differential circumferential forces occur in braking operations and then in particular in braking operations predominantly in the limiting range of the transmission of longitudinal forces. However, such different circumferential forces occur principally when the steered wheels are driven. The drive forces are transferred to the wheels but the wheels have different curve radii to travel along and thus different combinations of lateral forces and longitudinal forces and forces of different magnitude build up at the wheel. They are supported by means of the steering system, on which they act via the structurally provided interference force lever arm. These forces therefore no longer compensate one another when the steering is locked.

These forces are felt to be disruptive by the driver especially when the forces supported by means of the steering system comprise a very large component of the steering torque to be applied by the driver. This is the case, for example, when driving off with a large steering lock angle.

The occurrence of this technical problem is described, for example, in DE 35 41 732 A1 and DE 37 30 936 A1, the latter application applying in particular to rail vehicles and not to road vehicles, mechanical devices for force compensation being presented in said document as means of achieving the object

The object of the invention is, in contrast, to adapt the steering torque which is opposed to the activation of the steering wheel by the driver, in such a way that it is free of such interference influences.

This object is achieved by a method according to the invention.

In a motor vehicle, the steering torque which acts when a steering wheel is activated is determined. The motor vehicle is here in particular a motor vehicle whose steered wheels are driven. In this context, according to one method according to the invention, the interference torque component of the steering wheel torque which is based on interference influences is determined. A steering torque with reduced interference force is then generated at the steering wheel by means of a torque generator. According to the preferred embodiment of the invention, the steering torque with reduced interference force is free of the influence of an interference force.

By virtue of the fact that the interference torque component of the steering torque is determined in the vehicle, it is made possible for this part of the steering torque to be largely or entirely compensated by the torque generator at the steering wheel. The interference force is reduced here in accordance with the precision with which the interference force influences and the actuation of the torque generator are determined. As a result, the driver senses that the interference torque influence which comes about is at least reduced, and preferably it is not sensed at any more.

According to one preferred embodiment of the invention, the interference torque component is determined from wheel forces. It is possible, in particular, to use at least one of the forces comprising the wheel circumferential force, wheel normal force and wheel lateral force for this purpose, with these forces preferably being determined for at least some of the steered wheels. The wheel forces may be determined here using a model, in particular an observer. By using a model which in particular uses an axial model, the behavior of the axle can be satisfactorily simulated so that the interference force component can be satisfactorily determined. The models may be, in particular, observers, preferably model-supported observers.

The wheel forces are determined, in particular, using variables which are measured by means of sensors or determined in the vehicle. In this context, in particular variables from the set comprising the steering angle, yaw rate, vehicle speed, lateral acceleration, wheel speed, wheel braking pressures and drive torque are used. These variables advantageously permit interference torque components to be determined and they are incorporated, in particular, into the model or the observer. Furthermore, interference torques may be determined from wheel forces and measured variables, within inparticular an observer or at least one characteristic diagram being used for this purpose.

The steering torque which acts on the steering wheel is preferably reduced by correspondingly actuating a torque generator by the interference torque component which is determined. It is also possible to determine a setpoint steering torque which is free of influence of an interference force, and to apply the latter by means of the torque generator so that as a result a steering torque which is free of the influence of an interference force is generated at the steering wheel. Both variants permit the driver to operate the steering wheel in a pleasant way, free of interference torque components. The setpoint torque which is free of the influence of an interference torque can be determined, for this purpose, by means of a model, for example an observer, with, in particular, variables from the set comprising steering angle, yaw rate, vehicle speed, lateral acceleration, wheel speeds, wheel braking pressures and drive torque being used in this context.

Depending on the method for operation of the torque actuator, in order to generate the steering torque a torque which compensates the interference torque component is easily generated by the torque actuator, but if the entire steering torque is generated by the torque generator, the interference torque component is superimposed on the steering torque which is determined without considering the interference torque component, and the torque which results from this superimposition is applied as a steering torque.

It is also possible, in order to determine interference torques, to derive a specific driving situation from variables, such as the variables already mentioned above, and to determine the interference torques as a function of the detected driving situation.

According to one preferred embodiment of the invention, the steering torque is regulated. In this context, stochastic oscillation excitations—particularly in the natural frequency range of the steering system—can be senced as interference variables at steered wheels, referred to as shimmies, and compensated, even if the steering torque is controlled at the steering wheel. These oscillations which occur in specific driving situations are then no longer passed on to the steering wheel, and the comfort and the driving safety for the driver is thus increased.

The invention as well as advantageous refinements thereof are presented not only in the claims but also in the description. Furthermore, the invention will be explained in more detail below with reference to the exemplary embodiment presented in the drawing, in which:

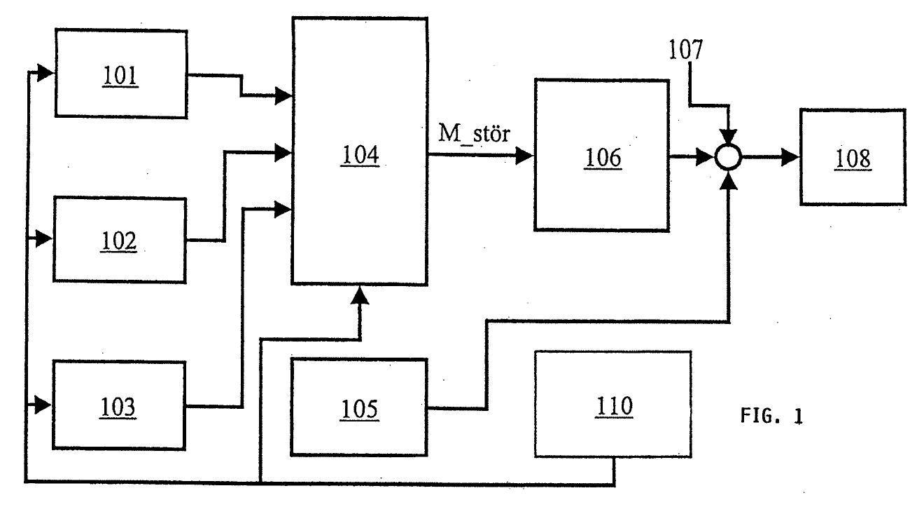

FIG. 1: is a block diagram of a method according to the invention for determining the steering wheel torque which is opposed to an activation; and

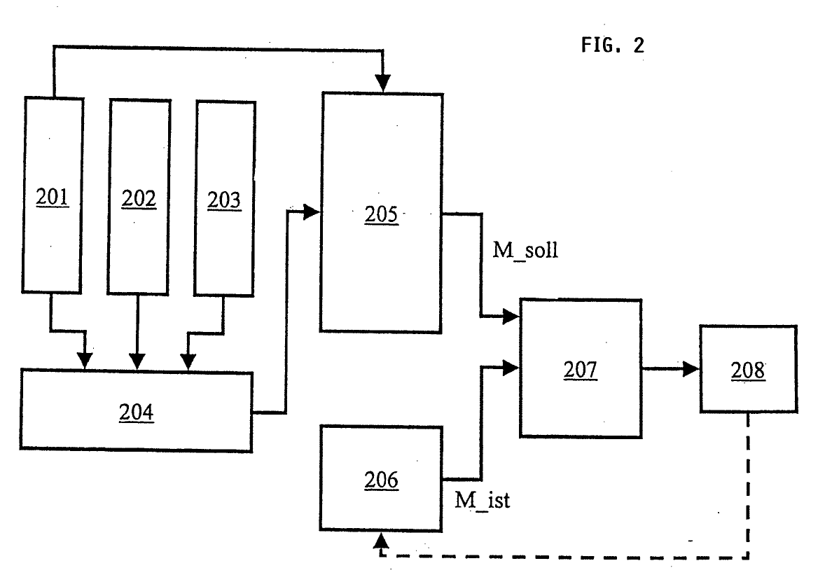

FIG. 2 is a block diagram of a method according to the invention for controlling the steering wheel torque which is opposed to an activation.

According to the exemplary embodiment illustrated in FIG. 1, the steering torque is controlled at the steering wheel. At first, input variables 110 are fed to the control system. These variables comprise in this context in particular at least some of the variables comprising the steering angle, yaw rate, vehicle speed, lateral acceleration, wheel speeds, wheel braking pressures and drive torque. These variables are usually measured by means of sensors and are present in any case as signals in the vehicle. The corresponding values are then merely additionally fed also to this control system, with the number of variables used being dependent on the models, observers and characteristic diagrams used in an individual case.

The input variables which are fed are fed to three different determining devices, 101, 102, 103, with the wheel circumferential forces being determined in the determining device 101, the wheel normal forces (wheel contact forces) in the determining device 102, and the wheel lateral forces in the determining device 103. The corresponding forces can be determined in each of the determining devices 101, 102, 103, in each case using a corresponding model such as a preferably model-supported observer, or using adapted characteristic diagrams.

The results of the determining devices 101, 102 and 103 are then fed to the determining device 104 in which the interference torque components are determined. The determining device 104 determines, once more using a model such as an observer or a characteristic diagram, the interference torque M_stör, on the basis of the variables comprising the steering angle and the wheel forces determined and, if appropriate, for the input variables 110.

This interference torque M_stör is then fed to the evaluation unit 106. In the evaluation unit, the control signal which is necessary for actuating the torque generator 108 is generated from the interference torque M_stör and then filtered in order to smooth it. The signal which is obtained in this way is fed to the adder element 107. According to the illustrated embodiment, a control signal, which is derived from a basic steering torque 105, is also fed to the adder element 107, with the basic steering torque being determined without taking into account interference torques. The basic steering torque is usually determined as a function of a characteristic diagram and is used to control the steering torque, for example as a function of the driving speed. These two actuation signals are combined in the adder element 107 and the resulting actuating signal is fed to the torque generator 108 which then generates the corresponding actuating torque which is applied to the torques transmitted in the steering column with the result that, on the one hand, these torques are reduced to a desired setpoint amount and, on the other hand, the steering torques are eliminated by compensation.

FIG. 2 shows an exemplary embodiment in which the steering torques are controlled at the steering wheel, and possible interference torques are thus also compensated. This provides a behavior of the steering wheel which is free from steering torque.

For this purpose, a control signal which brings about the generation of a steering torque is fed to the torque actuator 208 by the evaluation unit 207. The steering torque M_ist which is generated is sensed by means of the torque sensor 206 and fed back to the evaluation unit 207 in order to close the controlled system.

A setpoint torque is determined in the observer unit 205 and then fed to the evaluation unit 207. For this purpose, sensor signals 201, which represent dynamic variables of the vehicle such as the steering angle, yaw rate, vehicle speed and lateral acceleration, are fed to the observer unit 205. Furthermore, the signal from a driving situation detector 205 is also fed to the observer unit 205. A steering torque M_soll which is free of interference inputs is determined in the observer unit 205 from the driving situation detected in the driving situation detector 204 and from the sensor signals 201. In this context, preferably a model, in particular a model-supported observer, which serves as the basis for a vehicle model and in particular a steering model, is used for the determination process. Instead of the modeling by means of an observer which takes into account the driving situation it is also possible to predefine characteristic diagrams which are independent of the driving situation.

Sensors signals 201 which represent the driving state of the vehicle are fed to the driving situation detector in order to determine the driving situation. In addition, sensor signals 202 which represent the wheel behavior, an additionally or alternatively underlying surface information 203, are also fed. The underlying surface information 203 may originate here in particular from an optical road detection device such as camera or a navigation system. The sensor signals 202 which represent the wheel behavior include, in particular, information about the wheel speeds (rotational speeds of the wheels) as well as the wheel braking pressure. This information, in particular from the steered wheels, is then taken into account in the determination of the driving situation.

The driving situations which are determined or detected are, in particular, those during cornering with, in particular, the bend radius also being determined in this context in order to take into account side wind, situations with different coefficients of friction on the sides of the vehicle (μ-split) and situations with a low usable coefficient of friction (μ-useful).

In this way it is possible to determine a setpoint steering torque M_soll which is free of interfering influences. In particular such a control system makes it possible also to compensate at least partially stochastic oscillation excitations, in particular those in the region of the natural frequency of the steering system—referred to as shimmies—and to control the steering torque at the steering wheel in such a way that such influences can be felt less, and preferably cannot be felt. The steering torque which is determined in this way is used to improve the driving comfort and driving safety. The influences due to interference torques and overreaction or incorrect reaction by the driver are significantly reduced or entirely avoided.

In the claims:

1. A method for determining a steering torque acting when a steering wheel is activated in motor vehicles, in particular in motor vehicles which are driven on steered wheels, characterized in that the interference torque component (M_stör), based on interfering influences, of the steering torque (M_ist) is determined and the steering torque (M_ist) with reduced interference force is generated by means of a torque generator (108, 208).

2. The method as claimed in claim 1, characterized in that the steering torque (M_ist) with reduced interference force is determined in such a way that it is at least largely free of interference force.

3-16. (canceled)

17. The method as claimed in claim 1, characterized in that the interference torque component (M_stör) is determined from wheel forces (101, 102, 103, 201).

18. The method as claimed in claim 17, characterized in that the interference torque (M_stör) is determined from at least one of the forces comprising wheel circumferential forces (101), wheel normal forces (102) and wheel lateral forces (103).

19. The method as claimed in claim 17, characterized in that the wheel forces (101, 102, 103, 201) are determined using an observer.

20. The method as claimed in claim 17, characterized in that the wheel forces (101, 102, 103, 201) are determined using variables which are measured by means of sensors or which are determined in the vehicle, in particular variables from the set comprising steering angle, yaw rate, vehicle speed, lateral acceleration, wheel speeds, wheel brake pressures and drive torque.

21. The method as claimed in claim 1, characterized in that the interference torque component (M_stör) is determined from wheel forces (101, 102, 103, 201) and measured variables, wherein in particular a model, preferably an observer, or at least one characteristic diagram is used for this purpose.

22. The method as claimed in claim 2, characterized in that steering torque (M_ist) which acts on the steering wheel is reduced by the interference torque.

23. The method as claimed in claim 1, characterized in that a setpoint steering torque (M_soll) which is free of influence from an interference force is determined from variables.

24. The method as claimed in claim 23, characterized in that the setpoint steering torque (M_soll) which is free of influence from an interference force is determined by means of a model, in particular an observer, wherein in particular variables from the set of steering angle, yaw rate, vehicle speed, lateral acceleration, wheel speeds, wheel brake pressures and drive torque are used.

25. The method as claimed in claim 23, characterized in that a steering torque which is to be generated and an interference torque component (M_stör) for generating the steering torque are fed to the torque generator (108, 208).

26. The method as claimed in claim 1, characterized in that, in order to determine the interference torque component (M_stör), a driving situation is derived from variables and the interference torques (M_stör) are derived as a function of the driving situation.

27. The method as claimed in claim 1, characterized in that an actual torque (M_ist) of the steering torque is sensed and a steering torque which is free of interference torque is applied on the basis of the actual torque (M_ist) and the interference torque component (M_stör) which is determined.

28. The method as claimed in claim 1, characterized in that an actual torque (M_ist) of the steering torque is sensed and a steering torque (M_ist) which is free of the interference torque is applied on the basis of the actual torque (M_ist) and the setpoint torque (M_soll) which is free of influence from an interference torque.

29. The method as claimed in claim 27, characterized in that stochastic oscillation excitations of steered wheels are determined as interference torque components (M_stör).

30. A motor vehicle having a steering wheel for the driver to predefine a steering angle, and a torque generator for applying a steering torque to the steering wheel, characterized in that the steering torque is determined as claimed in claim 1.
